(19) United States
(12) Patent Application Publication
(10) Pub. No.: US 2025/0118165 A1
(43) Pub. Date: Apr. 10, 2025

(54) DUAL PLAY UNIVERSAL CABINET

(71) Applicant: Interblock d.o.o., Menges (SI)

(72) Inventor: John Joseph Connelly, Las Vegas, NV (US)

(21) Appl. No.: 18/888,446

(22) Filed: Sep. 18, 2024

Related U.S. Application Data
(60) Provisional application No. 63/588,895, filed on Oct. 9, 2023.

(51) Int. Cl. G07F 17/32

(52) U.S. Cl. CPC G07F 17/3276; G07F 17/323; G07F 17/3244

(57) ABSTRACT

The present disclosure relates to systems and methods for presenting a dual play mode in a gaming machine. Players may interact with player stations configured to communicate with each other. The player stations may be connected virtually, or the player stations may be connected physically, or both. The player stations may allow a plurality of players to play with, against, or alongside one another in a same game at a same time. For example, two players, three players, or more than three players may be able to interact directly through the plurality of player stations to play the same game together.

### CROSS REFERENCE TO RELATED APPLICATIONS

This application claims benefit under 35 U.S.C. § 119(e) of Provisional U.S. Patent Application No. 63/588,895, filed Oct. 9, 2023, the contents of which is incorporated herein by reference in its entirety.

### TECHNICAL FIELD

The present disclosure relates generally, but not exclusively, to the field of gaming, particularly to virtual interactive games.

### BACKGROUND INFORMATION

Casinos and gaming locations offer a variety of games to attract players. Such games may include live table games, traditional casino games (e.g., roulette, craps, blackjack, etc.), virtual games, physical machines (e.g., slot-like machines), individual gaming apparatus, stadium-style group stations, and various gameplay combinations.

There are a variety of casino games available for players to play as individuals, and there are a variety of casino games available for players to play in a group setting. For example, players may play at a slot machine individually. Players may play in a group setting at a craps table or a roulette table. However, there are limited options for playing games on individual gaming apparatuses in a group setting.

Even when there are physical machines that offer games with a linked portion, the group atmosphere of the linked portion of the games is limited. For example, slot machines may offer a progressive bonus among a plurality of like slot machines. As players play at different slot machines linked via a same progressive bonus, the progressive bonus increases based on the play of each player at the like slot machines. However, simply watching a progressive bonus increase may not be a desirable level of group play for a player that typically plays a physical machine or other individual gaming apparatus. Therefore, it is desirable to produce virtual games, physical machines, and other individual gaming apparatuses that may allow multiple players to play a game together, whether that be playing a same game with a common goal, or whether that be playing the same game head-to-head.

### SUMMARY

An embodiment is directed to systems and methods for dual play gaming, for example for dual play gaming on a universal cabinet. Aspects may comprise a first player station of a plurality of player stations, the first player station further comprising a processor and a memory, the memory comprising instructions, which when executed by the processor, cause the first player station to display, at a first portion of the first player station, an interactive gaming interface, wherein the interactive gaming interface is configured to accept one or more first actions associated with the first player station. The instructions may cause the first player station to display, at a second portion of the first player station, a gaming interface associated with a second player station of the plurality of player stations. The instructions may cause the first player station to update, based on at least one first action received at the interactive gaming interface, the display of the first portion of the first player station. The instructions may cause the first player station to update, based on at least one second action received at the second player station, the display of the second portion of the first player station. The embodiment may comprise the second player station of the plurality of player stations, wherein the first player station and the second player station are configured to participate in the same gaming event.

These and other features will be more clearly understood from the following detailed description taken in conjunction with the accompanying drawings and claims. This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a perspective view of a player station.

FIG. 2 is an exemplary view of a graphical user interface of the dual play mode described herein.

FIG. 3 is a perspective view of an exemplary gaming machine illustrating multiple player stations.

FIG. 4 is another embodiment of an exemplary gaming machine illustrating multiple player stations.

FIG. 5 is a top view of an exemplary gaming machine illustrating multiple player stations.

FIG. 6 is a flowchart for an example dual play mode at a gaming machinet.

FIG. 7 is an illustration of an exemplary block diagram representing a general-purpose computer system in which aspects of the methods and systems disclosed herein or portions thereof may be incorporated.

### DETAILED DESCRIPTION OF THE EMBODIMENTS

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

Disclosed herein are methods, systems, and computer readable storage media for gaming systems and techniques for presenting a dual play mode in a gaming machine. According to various aspects presented herein, players may interact with player stations configured to communicate with each other. The player stations may be connected virtually, or the player stations may be connected physically, or both. The player stations may allow a plurality of players to play with, against, or alongside one another in a same game at a same time. For example, two players, three players, or more than three players may be able to interact directly through the plurality of player stations to play the same game together.

For example, a player who prefers to play games in groups may be able to play a game at a player station in a dual play mode to play a game in a group, whereas the player may not have been able to play a similar game in a group previously. For example, a first player at a first player station may be able to make a bet and play a virtual or live machine game. A second player at a second player station associated with the first player station may simultaneously be able to make a bet at and play the same virtual or live machine game. Accordingly, the first player and the second player may be able to play the same game together at the same time.

Furthermore, the first player may be able to see information associated with the second player in real-time or near real-time. For example, the first player may interact with a graphical user interface associated with the first player station. The graphical user interface may comprise a portion associated with the first player's game, and the first player may be able to manipulate the first player's position in the game. For example, the first player may be able to place a main bet, place a side bet, or take an action associated with progressing the game. Additionally, the first player station may have another portion of the graphical user interface that shows a representative example of the second player station. For example, the first player station may be able to show a bet made at the second player station or an action taken at the second player station. The first player station may update the portion of the graphical user interface associated with the second player station as the second player makes changes to the state of the game on the second player station. For example, the second player may place a main bet and two side bets associated with a game. The first player station may initially comprise a default view of the second player station as seen prior to any actions being taken. The first player station may update a graphical user interface portion associated with the second player station to show the main bet and the two side bets made by the second player on the second player station. In this way, multiple players may play a game together.

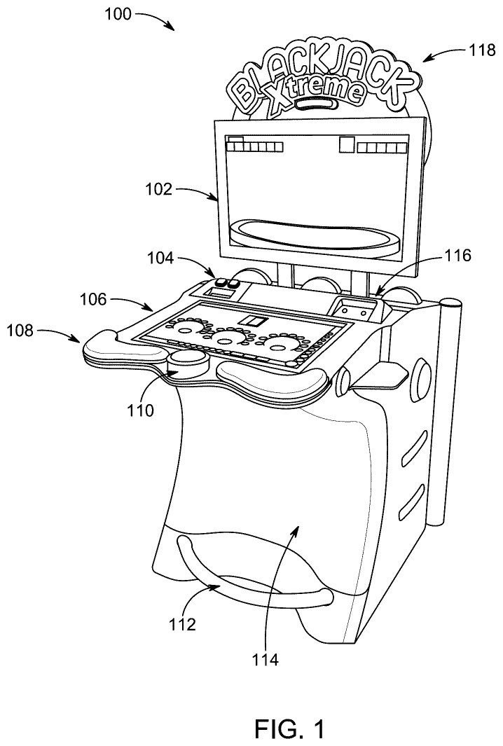

FIG. 1 shows an exemplary embodiment of a player station 100 associated with the disclosure herein. The gaming machine 100 may have a non-interactive overhead graphical user interface (GUI) 102 used to show information associated with a game. For example, in a blackjack game, the overhead GUI 102 may show a live or animated representation of a dealer at a blackjack table. As a new blackjack hand is being dealt to the player, the overhead GUI 102 may depict an example of a blackjack dealer dealing cards for a game of blackjack. The overhead GUI 102 may add to the immersive nature of the player station 100 by showing pictures or videos related to the game. The overhead GUI 102 may also show pictures or video clips to build excitement surrounding a game. For example, in a blackjack hand, it is desirable to be dealt a blackjack. Upon being dealt a blackjack at a first player station 100, the overhead GUI 102 may show a pre-designed video clip to celebrate the blackjack. For example, the video clip may show fireworks, the video clip may show a dealer congratulating the player, or the like.

The player station 100 may comprise a number of buttons, for example buttons 104. The buttons may be physical buttons, as opposed to virtual buttons on a GUI, but the buttons may alternatively be virtual buttons on a GUI associated with the player station 100. The player station may further comprise an armrest 108, providing comfort to players during gaming sessions. The armrest 108 may be made of a soft gel material, a plastic material, a fabric material, though it is not so limited. A footrest 112 may also be built into the player station 100 to provide additional comfort to players sitting at the player station 100.

The player station 100 may have built-in speakers 114 to play the sounds associated with the game. Though shown in the front of the base of the player station 100 in FIG. 1, the speakers may also be built-into any other suitable portion of the player station 100. The speakers may also be built into a different machine in proximity to the player station. The speakers 114 may be built into the base of the player station. The speakers may play a voice recording associated with a virtual dealer on the overhead GUI 102, or the speakers may play music or other tones based on a particular action taking place in the game or on the interactive GUI 106.

A control button 110 may be built into the near side of the player station 100. The control button may be a physical button used to control various aspects of the games played at the player station 100. For example, the control button 110 may be used to place a bet prior to a game starting. A money or card receiving and payment mechanism may also be placed in a convenient location on the player station 100, for example money/card mechanism 116 placed just behind the interactive GUI 106, though the disclosure is not so limited. The player station 100 may also comprise a built-in indicator, for example indicator 118. The indicator 118 may present information about the player station 100 or games available at the player station 100 to passersby. For example, the indicator 118 may indicate that the player station 100 is configured for “Blackjack Xtreme.” Therefore, a passing player could quickly glance at the indicator 118 and understand that the particular player station 100 would be used for playing Blackjack Xtreme.

The inside of the universal cabinet may include a controller module that may provide common connections for each of the different types of games and provide a USB connection to an embedded computer (not shown) in the bottom section of the player station 100. The embedded computer may be a GANLOT AMDY-7005, which is designed for gaming applications. The controller module may also provide outputs for the base cabinet lighting and buttons, which makes it possible to offer numerous gaming machine lighting designs. The controller module may also make it possible to quickly change toppers on the player station 100. Connections from the existing topper may be disconnected and the topper removed from the player station 100. The new topper may then be attached to the player station 100 and its connections plugged into the controller module. In an embodiment, a switch in the controller module may then be switched to correspond to the new topper. In other embodiments, the new topper can be identified by connecting or plugging one or more additional modules for that topper into the controller module or changing a program of the embedded computer. This may make it possible to quickly change the type of game that is being played on the player station 100 without have to remove the player station 100 from any row it is in and without moving other machines or forcing the other machines to be shut down. This may also make it possible to prototype and develop other toppers for new games, further reducing development and production costs.

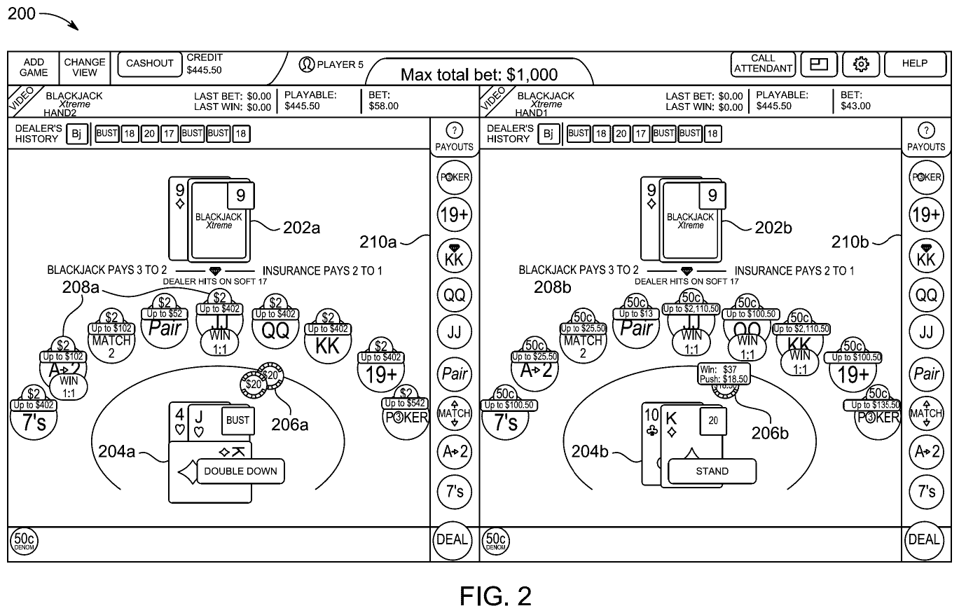

As described further with respect to FIG. 2, the interactive GUI 106 is the primary place for players to interact with a player station 100 during gameplay. For example, the interactive GUI 106 may be used to play bets, see other players' actions and payouts, read information about the game, or play the game. Players may interact with the interactive GUI 106, for example, the interactive GUI 106 may be made partially or fully of a touch capable screen. Players may tap, press, drag, or take other touch actions to interact with the interactive GUI 106 to affect the state of gameplay.

FIG. 2 shows an exemplary interactive GUI 200 as described above with respect to FIG. 1. The exemplary GUI 200 shown in FIG. 2 may describe a particular blackjack game available to players using player station 100. Additionally, GUI 200 may represent the dual play mode described herein. GUI 200 shows two separate layouts for two separate players playing a same game. For example, 202a shows the status of a dealer's blackjack hand during a game of virtual blackjack. The dealer is showing a nine of diamonds and has a facedown card that the players are unable to discern. Another player on the other side of the GUI 200 also sees the same information regarding the dealer's hand at 202b. Again, the player using the right side of GUI 200 sees the dealer with a nine of diamonds and an unknown card in a face down position. Because each player is playing the same game, it is important for the information about the game to be revealed simultaneously for each player. For example, if one player knew the dealer's face down card earlier than another player, the another player may have an advantage in playing his or her hand based on the earlier revealed secret knowledge. Additionally, revealing the information to all players in the same game simultaneously may help build excitement about the outcome of the game. Having the players see the same information at the same time also more closely simulates the experience of the two players playing the same game at a live action table instead of two individual universal cabinet electronic games.

At 204a, the left side of GUI 200 shows a player hand in a blackjack game. In the current state, the player has recently busted, by accruing a point total greater than 21, i.e., a four of hearts, a jack of hearts and a king of diamonds, as shown. However, the player on the other side of GUI 200 has a hand with a point total of 20. Therefore, the player on the right side of GUI 200 is still active in the game and waiting for the dealer to reveal the dealer's hand. In this manner, multiple players may play a game simultaneously. However, not everything in the game must act simultaneously. For example, each player may be dealt two cards initially. Play may continue in clockwise or anti-clockwise order, going one player at a time to determine an outcome of each player's hand. Therefore, the player on the right side of GUI 200 may act upon the dealt hand before the player on the left side of GUI 200 is able to take any actions. Alternatively, each may be provided a certain amount of time, based on a time, within which to make a decision, which may result in both players taking action at the same time, or not.

Players may play and place bets on any number of games on the player station 100. In the example shown in FIG. 2, the player on the left side of GUI 200 may place a $40 bet, as shown in 206a. the player on the right side of GUI 200 may place a different bet, for example an $18.50 bet, shown at 206b. Additionally, players may be able to place main bets and side bets depending on the game. In FIG. 2, 206a and 206b may represent main bets. Additionally, players may be able to place side bets. For example, the player on the left side of GUI 200 has placed a side bet 208a. On the other hand, the player on the right side of GUI 200 has not placed a side bet at 208a. However, the player on the right side of GUI 200 has placed other side bets, as shown by the lit icons in the semi-circle above the player's cards. The top bar of the GUI 200 may display a “credit” quantity, showing a betting reserve available to a player to place bets with.

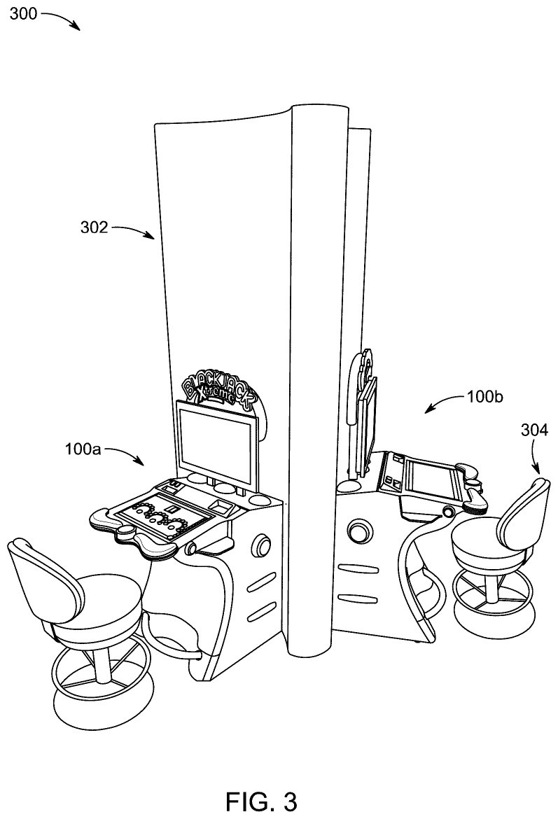

FIG. 3 shows an example of a plurality of player stations 100 configured around a central screen 302. The plurality of player stations 100 may be physically connected to one another, allowing for dual play, including head-to-head play among multiple players. For example, a first player may play a game (e.g., Blackjack Xtreme) at a first player station 100a in the gaming system 300. A second player may enter the same game from a second player station 100b set at the same gaming system 300 around the central screen 302. The central screen 302 may present graphical images, videos, lights, or sounds to complement the game played on each individual player station 100. The first player may be able to play the game from the first player station 100a, and the first player may be able to place bets and take actions regarding the game. Player two may be able to place bets and take actions on player station 100b with respect to the same game as the first player. Therefore, the two players are able to compete in dual play mode and play head-to-head with or against one another while also being able to physically see one another. Seat 304 is an illustrative example of a seat placed at the player stations 100 to provide for a comfortable gaming experience for players. Though only one particular seat 304 is described in FIG. 3, any number of types of seats may be placed at the player stations 100 to provide differing levels of comfort, control, or immersion into the games.

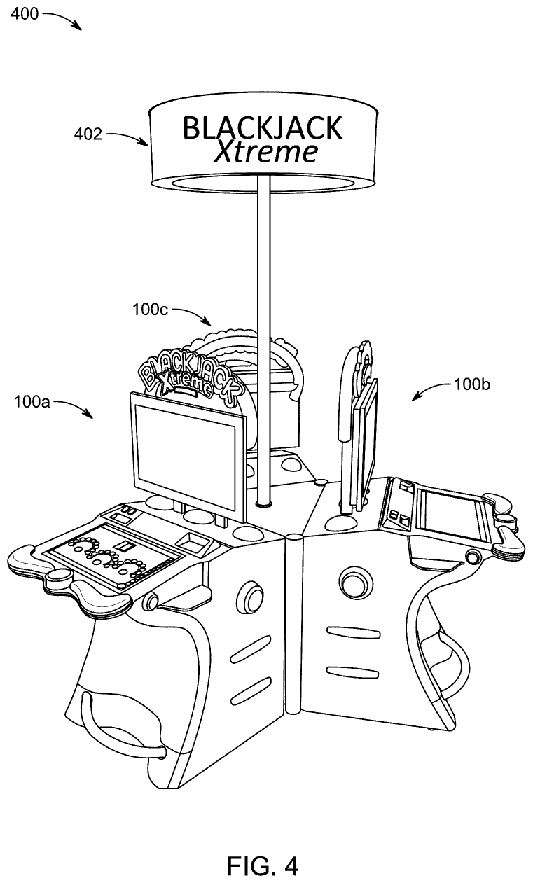

FIG. 4 shows another embodiment of the player stations 100 configured around a gaming system 400. In the embodiment described in FIG. 4, instead of a central screen, there is an overhead indicator 402. The indicator 402 may be placed several feet above the player stations 100 so that the gaming system is visible from afar. The indicator may be made of a plastic, metal, or the like material with an indication of a game permanently placed on the indicator. However, the indicator 402 may alternatively comprise a screen that is configurable. For example, the indicator may be an LED screen that can be reconfigured to show different words, phrases, pictures, or videos. Player stations 100a and 100b are shown in FIG. 4, as with FIG. 3. Additionally, player station 100c is explicitly shown in FIG. 4. As a non-limiting example, three player stations may be linked in order to allow for dual play gaming with three players. The three players may be able to all play the same game together, and each player may be able to see bets, actions, and outcomes associated with each other player at the gaming system. Although GUI 200 of FIG. 2 illustrates only two players playing at the same time, the GUI could be divided further to accommodate any number of additional players. Hence, while the game play is referred to as “dual play,” that just means that at least two players may play at once and does not limit the embodiments to only two players playing at the same time.

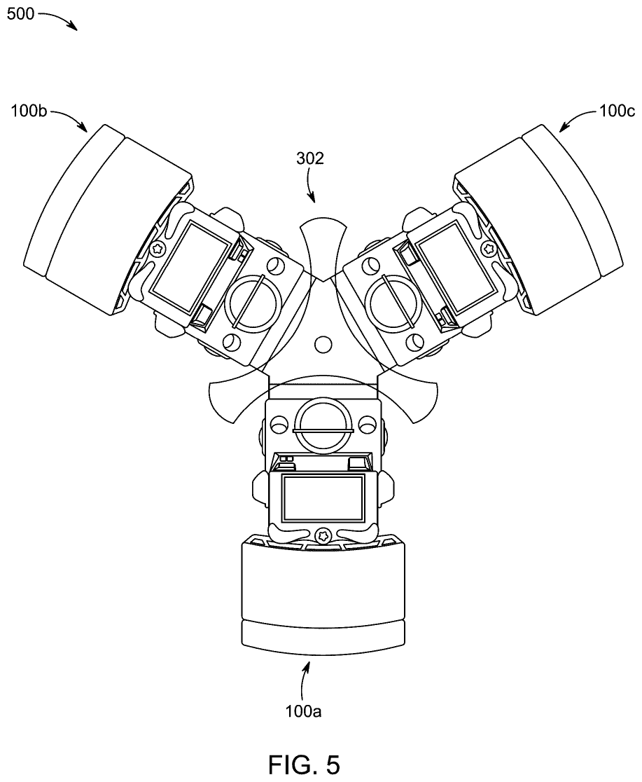

FIG. 5 presents an overhead view similar to the embodiment described in FIG. 3. In particular, however, FIG. 5 explicitly shows three player stations 100a, 100b, and 100c from a bird's eye view. The central screen 302 is also shown in FIG. 5, intersecting the three player stations and providing a visual barrier between the middle of the three. FIG. 5 is an example embodiment of a layout of the multiple linked player stations in a casino or other gaming location. Each one of the player stations 100a, 100b, and 100c is shown with a bench-type seat not described previously, but a bench-type seat is one of several possible seating configurations available to the dual play player stations 100. Though the central screen 302 blocks the center of the gaming system, players may still look to the side of the central screen 302 to see one another. For example, if one player in the dual play gaming wins a game, the other players may easily see and congratulate the winning player. As seen from above, each player at the player stations 100a, 100b, and 100c has access to their own player station 100, but each player is able to participate in head-to-head contests against one another during the dual play mode.

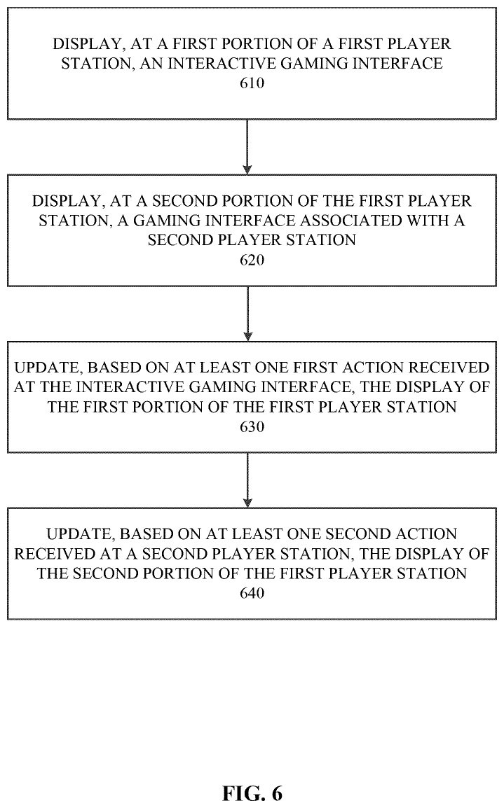

FIG. 6 is an example flow chart with gameplay operations of a dual play mode gaming system involving multiple players playing a same game against each other. At step 610, a GUI associated with a player station may display, at a first portion of a first player station, an interactive gaming interface.

At step 620, a GUI associated with the player station may display, at a second portion of the first player station, a gaming interface associated with a second player station.

At step 630, the GUI may update, based on at least one first action received at the interactive gaming interface, the display of the first portion of the first player station.

At step 640, the GUI may update, based on at least one second action received at a second player station, the display of the second portion of the first player station.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

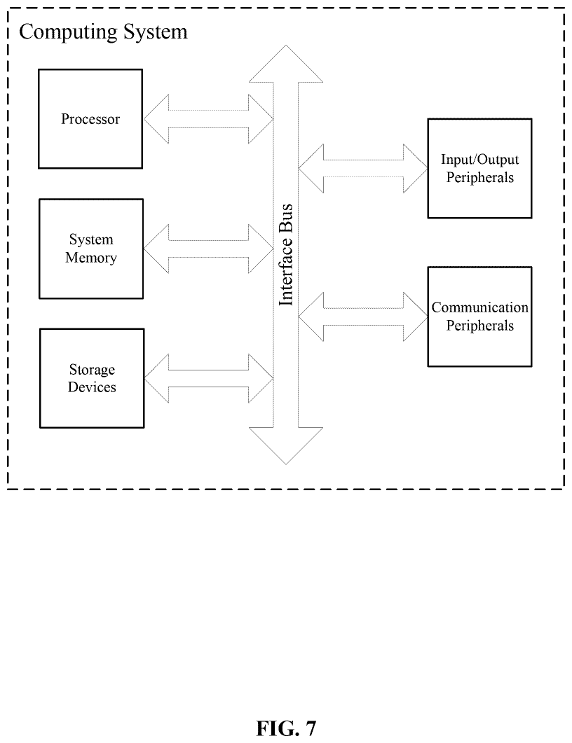

The techniques described above can be implemented on a computing device associated with a gaming device (e.g., a roulette machine operating a live roulette game), a plurality of computing devices associated with a plurality of gaming devices, a controller in communication with the gaming device(s) (e.g., a controller configured to synchronize the gaming devices(s)), or a plurality of controllers in communication with the gaming device(s). Additionally, the techniques may be distributed between the computing device(s) and the controller(s). FIG. 7 illustrates an exemplary block diagram of a computing system that includes hardware modules, software module, and a combination thereof and that can be implemented as the computing device and/or as the server.

In a basic configuration, the computing system may include at least a processor, a system memory, a storage device, input/output peripherals, communication peripherals, and an interface bus. Instructions stored in the memory may be executed by the processor to perform a variety of methods and operations, including the updating a player station GUI based on an action taken by a player at another player station, as described above. The computing system components may be present in the gaming device, in a server or other component of a network, or distributed between some combinations of such devices.

The interface bus is configured to communicate, transmit, and transfer data, controls, and commands between the various components of the electronic device. The system memory and the storage device comprise computer readable storage media, such as RAM, ROM, EEPROM, hard-drives, CD-ROMs, optical storage devices, magnetic storage devices, flash memory, and other tangible storage media. Any of such computer readable storage medium can be configured to store instructions or program codes embodying aspects of the disclosure. Additionally, the system memory comprises an operation system and applications. The processor is configured to execute the stored instructions and can comprise, for example, a logical processing unit, a microprocessor, a digital signal processor, and the like.

The system memory and the storage device may also comprise computer readable signal media. A computer readable signal medium may include a propagated data signal with computer readable program code embodied therein. Such a propagated signal may take any of variety of forms including, but not limited to, electro-magnetic, optical, or any combination thereof. A computer readable signal medium may be any computer readable medium that is not a computer readable storage medium and that can communicate, propagate, or transport a program for use in connection with the computing system.

Further, the input and output peripherals include user interfaces such as a keyboard, screen, microphone, speaker, other input/output devices, and computing components such as digital-to-analog and analog-to-digital converters, graphical processing units, serial ports, parallel ports, and universal serial bus. The input/output peripherals may also include a variety of sensors, such as light, proximity, GPS, magnetic field, altitude, and velocity/acceleration. RSSI, and distance sensors, as well as other types of sensors. The input/output peripherals may be connected to the processor through any of the ports coupled to the interface bus.

The user interfaces can be configured to allow a user of the computing system to interact with the computing system. For example, the computing system may include instructions that, when executed, cause the computing system to generate a user interface and carry out other methods and operations that the user can use to provide input to the computing system and to receive an output from the computing system.

This user interface may be in the form of a graphical user interface that is rendered at the screen and that is coupled with audio transmitted on the speaker and microphone and input received at the keyboard. In an embodiment, the user interface can be locally generated at the computing system. In another embodiment, the user interface may be hosted on a remote computing system and rendered at the computing system. For example, the server may generate the user interface and may transmit information related thereto to the computing device that, in turn, renders the user interface to the user. The computing device may, for example, execute a browser or an application that exposes an application program interface (API) at the server to access the user interface hosted on the server.

Finally, the communication peripherals of the computing system are configured to facilitate communication between the computing system and other computing systems (e.g., between the computing device and the server) over a communications network. The communication peripherals include, for example, a network interface controller, modem, various modulators/demodulators and encoders/decoders, wireless and wired interface cards, antenna, and the like.

The communication network includes a network of any type that is suitable for providing communications between the computing device and the server and may comprise a combination of discrete networks which may use different technologies. For example, the communications network includes a cellular network, a Wi-Fi/broadband network, a local area network (LAN), a wide area network (WAN), a telephony network, a fiber-optic network, or combinations thereof. In an example embodiment, the communication network includes the Internet and any networks adapted to communicate with the Internet. The communications network may be also configured as a means for transmitting data between the computing device and the server.

The techniques described above may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile, or non-volatile storage.

In an embodiment, a dual play gaming system is described, comprising: a first player station of a plurality of player stations comprising a processor and a memory, the memory comprising instructions, which when executed by the processor, cause the first player station to: display, at a first portion of the first player station, an interactive gaming interface, wherein the interactive gaming interface is configured to accept one or more first actions associated with the first player station; display, at a second portion of the first player station, a gaming interface associated with a second player station of the plurality of player stations; update, based on at least one first action received at the interactive gaming interface, the display of the first portion of the first player station; and update, based on at least one second action received at the second player station, the display of the second portion of the first player station; and the second player station of the plurality of player stations, wherein the first player station and the second player station are configured to participate in the same gaming event.

In an embodiment, the dual play gaming system of claim 1, wherein the one or more first actions and the at least one second action comprise a bet associated with the gaming event.

In an embodiment, the dual play gaming system of claim 2, wherein the bet comprises at least one of a main bet and a side bet.

In an embodiment, the dual play gaming system of claim 2, wherein the instructions, when executed by the processor, further cause the first player station to: receive, at the interactive gaming interface, an indication of a first bet associated with the first player station; deduct, from a betting reserve, a first value equal to the first bet; receive an indication of a second bet associated with the second player station; and deduct, from the betting reserve, a second value equal to the second bet.

In an embodiment, the dual play gaming system of claim 2, wherein the instructions, when executed by the processor, further cause the first player station to: determine, based on the at least one first action, a win associated with a first bet and a first wager associated with the first bet; add, to a betting reserve, a first value equal to the first bet; determine, based on the at least one second action, a loss associated with a second bet and a second wager associated with the second bet; and deduct, from the betting reserve, a second value equal to the second bet.

In an embodiment, the dual play gaming system of claim 2, wherein the instructions, when executed by the processor, further cause the first player station to: determine, based on the at least one first action, a win associated with a first bet and a first wager associated with the second bet; add, to a betting reserve, a first value equal to the first bet; determine, based on the at least one second action, a win associated with a second bet and a second wager associated with the second bet; and add, to the betting reserve, a second value equal to the second bet.

In an embodiment, the dual play gaming system of claim 1, further comprising a third player station of the plurality of player stations, wherein the instructions, when executed by the processor, further cause the first player station to: display, at a third portion of the first player station, another gaming interface associated with the third player station of the plurality of player stations; and update, based on at least one third action received at the third player station, the display of the third portion of the first player station, wherein the first player station, the second player station, and the third player station are configured to participate in the same gaming event.

In an embodiment, the dual play gaming system of claim 1, wherein the second portion of the first player station is updated in near real-time based on the at least one second action.

In an embodiment, the dual play gaming system of claim 1, wherein each player station of the plurality of player stations is physically connected to a community device.

In an embodiment, the dual play gaming system of claim 9, wherein the community device comprises at least one of a community video screen, an overhead display feature, and a community gaming device.

In an embodiment, the dual play gaming system of claim 1, wherein causing the first player station and the second player station to participate in the same gaming event further comprises at least one of: the first player station competing against the second player station; and the first player station competing on a same team as the second player station.

In an embodiment, a dual play player station is configured to operate an interactive gaming event, the player station further comprising a processor and a memory, the memory comprising instructions, which when executed by the processor, cause the player station to: display, at a first portion of the player station, a first interactive gaming interface associated with a first user, wherein the first interactive gaming interface is configured to accept one or more first actions associated with the first user; display, at a second portion of the player station, a second interactive gaming interface associated with a second user, wherein the second interactive gaming interface is configured to accept one or more second actions associated with the second user; update, based on receiving at least one of the one or more first actions at the first interactive gaming interface, the display of the first interactive gaming interface; update, based on receiving at least one of the one or more second actions at the second interactive gaming interface, the display of the second interactive gaming interface; and display an outcome of the interactive gaming event based at least in part on the first interactive gaming interface and the second interactive gaming interface.

In an embodiment, the dual play player station of claim 12, wherein the one or more first actions and the one or more second actions comprise a bet associated with the interactive gaming event.

In an embodiment, the dual play player station of claim 13, wherein the bet comprises at least one of a main bet and a side bet.

In an embodiment, the dual play player station of claim 13, wherein the instructions, when executed by the processor, further cause the player station to: receive, at the first interactive gaming interface, an indication of a first bet associated with the first user; deduct, from a betting reserve, a first value equal to the first bet; receive an indication of a second bet associated with the second interactive gaming interface; and deduct, from the betting reserve, a second value equal to the second bet.

In an embodiment, the dual play player station of claim 13, wherein the instructions, when executed by the processor, further cause the player station to: determine, based on the one or more first actions, a win associated with a first bet and a first wager associated with the first bet; add, to a betting reserve, a first value equal to the first bet; determine, based on the one or more second actions, a loss associated with a second bet and a second wager associated with the second bet; and deduct, from the betting reserve, a second value equal to the second bet.

In an embodiment, the dual play player station of claim 13, wherein the instructions, when executed by the processor, further cause the player station to: determine, based on the one or more first actions, a win associated with a first bet and a first wager associated with the second bet; add, to a betting reserve, a first value equal to the first bet; determine, based on the one or more second actions, a win associated with a second bet and a second wager associated with the second bet; and add, to the betting reserve, a second value equal to the second bet.

In an embodiment, the dual play player station of claim 12, further comprising a third interactive gaming interface associated with the player station, wherein the instructions, when executed by the processor, further cause the player station to: display, at a third portion of the player station, a third interactive gaming interface associated with a third user; and update, based on at least one third action received at the third interactive gaming interface, the display of the third interactive gaming interface, wherein the first user, the second user, and the third user are configured to participate in the same interactive gaming event.

In an embodiment, the dual play gaming system of claim 12, wherein the player station is physically connected to at least one additional player station.

In an embodiment, the dual play player station of claim 19, wherein the player station and the additional player station are physically connected to a community device, wherein the community device comprises at least one of a community video screen, an overhead display feature, and a community gaming device.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

The present disclosure describes particular embodiments and their detailed construction and operation. The embodiments described herein are set forth by way of illustration only and not limitation. Those skilled in the art will recognize, in light of the teachings herein, that there may be a range of equivalents to the exemplary embodiments described herein. Most notably, other embodiments are possible, variations can be made to the embodiments described herein, and there may be equivalents to the components, parts, or steps that make up the described embodiments. For the sake of clarity and conciseness, certain aspects of components or steps of certain embodiments are presented without undue detail where such detail would be apparent to those skilled in the art in light of the teachings herein and/or where such detail would obfuscate an understanding of more pertinent aspects of the embodiments.

The terms and descriptions used above are set forth by way of illustration only and are not meant as limitations. Those skilled in the art will recognize that those and many other variations, enhancements and modifications of the concepts described herein are possible without departing from the underlying principles of the invention. The scope of the invention should therefore be determined only by the following claims and their equivalents.

What is claimed is:

1. A gaming system, comprising:
a first player station of a plurality of player stations comprising a processor and a memory, the memory comprising instructions, which when executed by the processor, cause the first player station to:
display, at a first portion of the first player station, an interactive gaming interface, wherein the interactive gaming interface is configured to accept one or more first actions associated with the first player station;
display, at a second portion of the first player station, a gaming interface associated with a second player station of the plurality of player stations;
update, based on at least one first action received at the interactive gaming interface, the display of the first portion of the first player station; and
update, based on at least one second action received at the second player station, the display of the second portion of the first player station; and
the second player station of the plurality of player stations, wherein the first player station and the second player station are configured to participate in the same gaming event.

2. The gaming system of claim 1, wherein the one or more first actions and the at least one second action comprise a bet associated with the gaming event.

3. The gaming system of claim 2, wherein the bet comprises at least one of a main bet and a side bet.

4. The gaming system of claim 2, wherein the instructions, when executed by the processor, further cause the first player station to:
receive, at the interactive gaming interface, an indication of a first bet associated with the first player station;
deduct, from a betting reserve, a first value equal to the first bet;
receive an indication of a second bet associated with the second player station; and
deduct, from the betting reserve, a second value equal to the second bet.

5. The gaming system of claim 2, wherein the instructions, when executed by the processor, further cause the first player station to:
determine, based on the at least one first action, a win associated with a first bet and a first wager associated with the first bet;
add, to a betting reserve, a first value equal to the first bet;
determine, based on the at least one second action, a loss associated with a second bet and a second wager associated with the second bet; and
deduct, from the betting reserve, a second value equal to the second bet.

6. The gaming system of claim 2, wherein the instructions, when executed by the processor, further cause the first player station to:
determine, based on the at least one first action, a win associated with a first bet and a first wager associated with the second bet;
add, to a betting reserve, a first value equal to the first bet;
determine, based on the at least one second action, a win associated with a second bet and a second wager associated with the second bet; and
add, to the betting reserve, a second value equal to the second bet.

7. The gaming system of claim 1, further comprising a third player station of the plurality of player stations, wherein the instructions, when executed by the processor, further cause the first player station to:
display, at a third portion of the first player station, another gaming interface associated with the third player station of the plurality of player stations; and
update, based on at least one third action received at the third player station, the display of the third portion of the first player station, wherein the first player station, the second player station, and the third player station are configured to participate in the same gaming event.

8. The gaming system of claim 1, wherein the second portion of the first player station is updated in near real-time based on the at least one second action.

9. The gaming system of claim 1, wherein each player station of the plurality of player stations is physically connected to a community device.

10. The gaming system of claim 9, wherein the community device comprises at least one of a community video screen, an overhead display feature, and a community gaming device.

11. The gaming system of claim 1, wherein causing the first player station and the second player station to participate in the same gaming event further comprises at least one of:
the first player station competing against the second player station; and
the first player station competing on a same team as the second player station.

12. A player station configured to operate an interactive gaming event, the player station further comprising a processor and a memory, the memory comprising instructions, which when executed by the processor, cause the player station to:
display, at a first portion of the player station, a first interactive gaming interface associated with a first user, wherein the first interactive gaming interface is configured to accept one or more first actions associated with the first user;
display, at a second portion of the player station, a second interactive gaming interface associated with a second user, wherein the second interactive gaming interface is configured to accept one or more second actions associated with the second user;
update, based on receiving at least one of the one or more first actions at the first interactive gaming interface, the display of the first interactive gaming interface;
update, based on receiving at least one of the one or more second actions at the second interactive gaming interface, the display of the second interactive gaming interface; and
display an outcome of the interactive gaming event based at least in part on the first interactive gaming interface and the second interactive gaming interface.

13. The player station of claim 12, wherein the one or more first actions and the one or more second actions comprise a bet associated with the interactive gaming event.

14. The player station of claim 13, wherein the bet comprises at least one of a main bet and a side bet.

15. The player station of claim 13, wherein the instructions, when executed by the processor, further cause the player station to:
receive, at the first interactive gaming interface, an indication of a first bet associated with the first user;
deduct, from a betting reserve, a first value equal to the first bet;
receive an indication of a second bet associated with the second interactive gaming interface; and
deduct, from the betting reserve, a second value equal to the second bet.

16. The player station of claim 13, wherein the instructions, when executed by the processor, further cause the player station to:
determine, based on the one or more first actions, a win associated with a first bet and a first wager associated with the first bet;
add, to a betting reserve, a first value equal to the first bet;
determine, based on the one or more second actions, a loss associated with a second bet and a second wager associated with the second bet; and
deduct, from the betting reserve, a second value equal to the second bet.

17. The player station of claim 13, wherein the instructions, when executed by the processor, further cause the player station to:
determine, based on the one or more first actions, a win associated with a first bet and a first wager associated with the second bet;
add, to a betting reserve, a first value equal to the first bet;
determine, based on the one or more second actions, a win associated with a second bet and a second wager associated with the second bet; and
add, to the betting reserve, a second value equal to the second bet.

18. The player station of claim 12, further comprising a third interactive gaming interface associated with the player station, wherein the instructions, when executed by the processor, further cause the player station to:
display, at a third portion of the player station, a third interactive gaming interface associated with a third user; and
update, based on at least one third action received at the third interactive gaming interface, the display of the third interactive gaming interface, wherein the first user, the second user, and the third user are configured to participate in the same interactive gaming event.

19. The gaming system of claim 12, wherein the player station is physically connected to at least one additional player station.

20. The player station of claim 19, wherein the player station and the additional player station are physically connected to a community device, wherein the community device comprises at least one of a community video screen, an overhead display feature, and a community gaming device.
